(19) United States
(12) Patent Application Publication
(10) Pub. No.: US 2010/0225025 A1
(43) Pub. Date: Sep. 9, 2010

(54) PROCESS AND DEVICE FOR CASCADE INJECTION MOLDING

(75) Inventor: Christian Striegel, Hainburg (DE)

Correspondence Address: BUTZEL LONG;IP DOCKETING DEPT, 350 SOUTH MAIN STREET, SUITE 300, ANN ARBOR, MI, 48104, US

(73) Assignee: Incoe Corporation, Troy, MI (US)

(21) Appl. No.: 12/694,870

(22) Filed: Jan. 27, 2010

(30) Foreign Application Priority Data
Mar. 6, 2009 (DE) 10 2009 012 082.3

(51) Int. Cl. B29C 45/13

(52) U.S. Cl. 264/328.8; 425/130

(57) ABSTRACT

A cascade injection molding system includes a plurality of nozzles each having a valve rod driven by a piston cylinder drive, for injecting melt into the mold cavity. A throttle check valve is located within a pressurizing medium line to regulate nozzle operation. The method includes injecting the melt at feed orifice using a needle valve-controlled needle valve nozzle associated with each feed orifice into the cavity of the molding tool. The needle valve nozzles is opened at different times by controlling the opening speed and the injection pressure at the feed orifices, via the corresponding piston-cylinder drives for the needle valve nozzles. The pressurizing medium discharge from the piston cylinder is throttled for at least one of the piston-cylinder drives when the nozzle is opened.

### CROSS REFERENCE TO RELATED APPLICATIONS

This application claims the benefit of and priority to German Patent Application No. 10 2009 012 082.3, filed Mar. 6, 2009, which is incorporated herein by reference.

### BACKGROUND

The present invention relates to a process and device for injection molding, in particular to a cascade injection molding process.

In the injection molding of flat and/or elongated parts through a single ingate (feed orifice) it is difficult to fill the cavity of the molding tool completely with melt. Furthermore, when areas of the cavity which are distant from the feed orifice are reached by the melt, its temperature is already clearly reduced, due to which inhomogeneities in the structure of the molded parts can arise.

For this reason it is a known practice, particularly in the case of the molding of elongated and/or flat parts, to fill the cavity of the molding tool with melt through several feed orifices. In connection with this, flow lines result from the melt flow fronts issuing from the feed orifices meeting one another somewhere between neighboring feed orifices. Such flow lines represent weak points in the injected parts. Furthermore, the flow lines, depending on their material, surface, or color, may be visible on the surface of the part so that such parts must subsequently be treated by finishing.

In order to prevent such flow lines from arising, it is a known practice when using needle valve nozzles to open the different nozzles at different times. For example, the process begins with injection through a first nozzle and when the flow front issuing from that nozzle has reached the feed orifice of a neighboring nozzle opening that neighboring nozzle. The opening of the nozzles which are still further removed from the first nozzle is postponed in a corresponding manner. The situation is analogous to when the injection process begins through a central feed orifice which is encircled by several additional feed orifices, preferably lying on a circular arc around the first feed orifice. These encircling feed orifices open when the flow front from the central feed orifice has reached or passed them. This process of injection at intervals of time through several needle valve nozzles is called “cascade injection molding”.

The cascade process described so far has the disadvantage that on the opening of a second nozzle, or additional nozzles, the melt is injected at the pressure predetermined by the injection molding machine and the pressure is of equal magnitude for all the nozzles. Since when the flow front of a previously opened nozzle arrives at the feed orifice of a neighboring nozzle the melt of that flow front has already suffered a cooling and a loss of pressure, undesirable flow front markings arise due to melt under full pressure appearing explosively at the nozzle which opens later. This can be avoided by the later opening nozzles not being opened suddenly but rather slowly and to reduce the initial injection pressure.

In order to achieve a reduced initial injection pressure, a throttle device may be provided in the individual melt channel for a nozzle or in the melt channel of the nozzle itself. The throttle device is actuated by the valve rod, and a pressure sensor may be utilized which measures the pressure of the melt downstream from the throttle device. This measured value of the pressure is compared to a theoretical value of the pressure and the deviation governs the positioning of the piston in the piston-cylinder drive for the valve rod of the nozzle. Although this device for preventing an explosive entry of melt at temporally downstream feed orifices works, it has the disadvantage that it is very expensive. A control arrangement must be provided separately for each nozzle whose opening is delayed. Either a structural intervention in the hot runner-distributor block of the injection molding device is required or special nozzles are required.

Thus, there is a need in the art for developing a process as well as a device which is suitable for carrying out the process, where with the process and device the explosive discharge of the melt at the temporally downstream feed orifices is prevented in a simple and economical but still satisfactory manner.

### SUMMARY

A method of cascade injection molding of injection-molded articles, said method including the steps of: injecting the melt at more than one feed orifice using a needle valve-controlled needle valve nozzle associated with each feed orifice, into the cavity of the molding tool; opening the needle valve nozzles at different times using a process means for controlling the opening speed of the needle valve nozzles, and the injection pressure at the feed orifices, via the corresponding piston-cylinder drives for the needle valve nozzles; and throttling the pressurizing medium discharge from the piston cylinder for at least one of the piston-cylinder drives when the nozzle is opened.

A method of injection molding of injection-molded articles, said method including the steps of: injecting the melt is injected at one or more feed orifices using a needle valve-controlled needle valve nozzle associated with each feed orifice, into the cavity of the molding tool; using a process means for controlling, via the corresponding piston-cylinder drive, the opening speed of the needle valve nozzle and thus the injection pressure at the feed orifice for the needle valve nozzle; and throttling the pressurizing medium discharge from the piston cylinder drive for at least one of the piston-cylinder drives when the nozzle is opened.

A cascade injection molding system for injecting melt into a mold cavity, the system comprising: a plurality of nozzles each having a valve rod driven by a piston-cylinder drive having a cylinder space, the plurality of nozzles for injecting the melt into the mold cavity; a plurality of change-over valves coupled to a pressurizing medium line and a depressurized tank space, the change-over valves for controlling the piston-cylinder drives; and a throttle check valve located within the pressurizing medium line for regulating the opening and closing of at least one nozzle according to a predetermined time delay, and to prevent explosive discharge of the melt into the mold cavity upon opening of at least one of the nozzles.

A method of injecting melt into a mold cavity, the method comprising the steps of: opening a first nozzle and injecting a melt into the mold cavity via the first nozzle; adjusting the opening speed of a second nozzle via a throttle check valve located within a pressurizing medium line coupled to the second nozzle to thereby regulate the injection pressure; and opening the second nozzle and injecting the melt into the mold cavity via the second nozzle such that explosive discharge of the melt upon opening of the second nozzle is prevented.

An advantage of the present apparatus and method is that this process can be used in injection molding systems with only one feed orifice per cavity, or more feed orifices per cavity, and when using needle valve nozzles without cascade injection molding. Another advantage is that the process and the device for carrying it out require no change in design of the existing injection devices. A further advantage is that the process is suitable for hydraulically operated needle valve nozzles as well as for pneumatically operated needle valve nozzles. Still a further advantage is that undesirable markings can be prevented or mitigated by the process and the device for carrying it out. Yet a further advantage of this is an improved flow rate of the melt.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a schematic of an injection molding system for cascade injection molding, according to an exemplary embodiment.

FIG. 2 is an enlarged scale schematic of the additional device for carrying out the cascade injection molding process, according to an exemplary embodiment.

FIG. 3 is a schematic of the additional device for carrying out the cascade injection molding which is suitable in particular for pneumatically driven needle valve nozzles, according to an exemplary embodiment.

FIG. 4 is a schematic of the additional device for carrying out the cascade injection molding process, according to another exemplary embodiment.

FIG. 5 is an illustration of a molded part produced according to the process of the present disclosure.

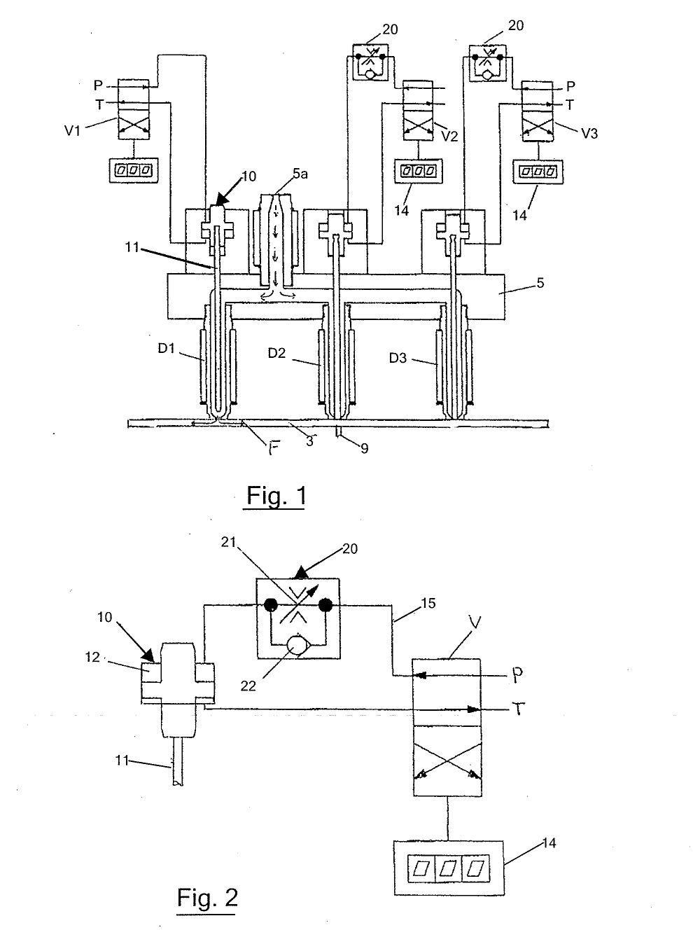

In the injection molding system according to FIG. 1, three needle valve nozzles D1 to D3 are connected to the flat, elongated cavity 3 of the molding tool which is not represented in other respects. The closing and opening of the feed orifices of the nozzles is accomplished via valve rods 11, each of which is driven by its piston-cylinder drive 10. The melt is fed to the nozzles via the hot runner-distributor block 5, which is connected at 5a to the injection-molding machine, which is not shown. Each piston-cylinder drive 10 is controlled by a respective change-over valve V1, V2, and V3. The change-over valves are connected via their connection P to a source of pressurizing medium (not shown) and via their connection T to a depressurized tank space.

In cascade injection molding using the injection molding system according to FIG. 1, the nozzle D1 opens first. When the flow front F has reached or passed the feed orifice of the nozzle D2, the nozzle 2 opens and correspondingly the nozzle D3 opens when the flow front F has arrived at the feed orifice of the nozzle D3.

Via time-setting elements 14, the respective delay times for the opening and closing of the nozzles can be set. For example, these delay times may be determined empirically. In another example, sensors at the feed orifices in the molding tool can be provided for the determination of the correct time to open the temporally downstream nozzles. Various types of sensors are contemplated, such as an optical sensor that operates on an optical basis or a pressure sensor that operates on the basis of pressure or a temperature sensor that operates on the temperature, by the arrival of the flow front being registered in a channel indicated at 9 in the mold's lateral ejection part, which is not represented in FIG. 1.

In FIG. 1, 20 denotes the additional device by which the process can be carried out, that is, the result is obtained such that when the temporally downstream nozzles open, an explosive discharge of the melt is avoided.

FIG. 2 shows this additional device on an enlarged scale. The device consists of a throttle check valve 20 which is introduced into the pressurizing medium line 15, which is connected to the cylinder space 12 of the piston-cylinder drive 10 via which the nozzle is closed when pressurizing medium is fed to the cylinder space 12. The throttle check valve 20 consists of an adjustable throttle 21 and, lying parallel thereto, a check valve 22 whose direction of passage is toward the piston-cylinder drive 10.

The throttle 21 prevents a sudden flow of the pressurizing medium out of the cylinder space 12, and thus a sudden opening of the temporally downstream nozzle and thus the explosive injection of the melt into the cavity, so that no flow front markings on the injected object result. In contrast, the closing of the needle valve nozzle is done suddenly via the check valve 22 lying parallel to the throttle 21.

For the discharge of pressurizing medium from the cylinder space 12, such a throttle check valve 20 is required for each nozzle opening with a time delay.

In the embodiment example according to FIG. 1, a throttle check valve 20 is absent in the pressurizing medium line for the nozzle D1 because in this example it is assumed that the nozzle D1 opens first for cascade molding. A throttle check valve 20 may be provided in the pressurizing medium circuit of each nozzle since it is not known in advance through which nozzle injection will occur first. A throttle check valve 20 can also have advantages when the injection molding is not cascade injection molding, as discussed above.

In the case of pneumatically controlled needle valve nozzles, the effectiveness of the device described with the aid of FIG. 2 may be limited due to the fact that a gaseous pressurizing medium is compressible. In order to achieve equivalent, processing can be done with a device represented in FIG. 3. In this case the pneumatically controlled piston-cylinder drive 10 for the valve needle is mechanically coupled, in an arbitrary manner, to a piston-cylinder device 30. The two cylinder chambers 32 and 33 are filled with a liquid pressurizing medium and connected to one another via a short-circuit line 31, which is also filled with liquid pressurizing medium. Lying in the short-circuit line is the previously described device consisting of an adjustable throttle 21 and, lying parallel thereto, a one-way element 22, such as a commercially available, adjustable throttle check valve. Therein the direction of passage of the one-way element is such that it can be passed through on the closing of the nozzle. When the nozzle opens, the liquid pressurizing medium which is to be expelled from the chamber 32 is then forced in the short-circuit line 31 through the throttle 21, whereby the opening movement of the valve needle 11 is slowed down.

Another example of a throttle device 21 used with the additional device 20 for carrying out the process according to the invention, is a commercially available, electrically controllable proportional flow-control valve 40, which is indicated in FIG. 4 by the encircling dotted line. Such a flow-control valve is actuated via an electromagnet 44 and a spring 41, in order to adjust the intensity of the throttling can be adjusted. Moreover, such a flow-control valve has additional adjustment capabilities, which, however, have no significance for the present invention. Thus, the through-flow for the pressurizing medium can be interrupted completely by the flow-control valve 40 being in the position indicated in FIG. 4. Furthermore, the flow-control valve can have an emergency actuation push button 43.

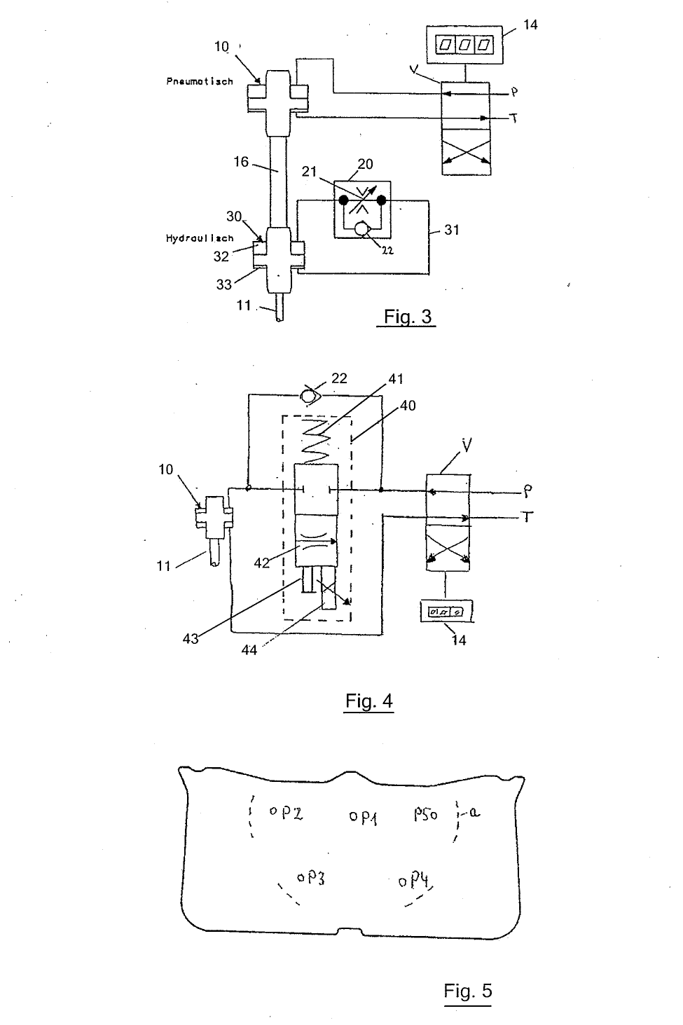

FIG. 5 shows, as an example of an injection-molded part, a molded tailgate for a motor vehicle. The mold with which this object is produced has, for example, the five indicated injection points P1 to P5. During the molding process according to the method provided, the nozzle first opens at P1, from which point the flow front of the melt extends in an approximately circular shape and, at approximately the same time, reaches all four injection points P2 to P5, which are then opened. Thanks to the inventive gentle initiation of the inflow of the melt through the injection points P2 to P5, undesirable unsightly flow front markings, as are indicated in FIG. 5 by the dotted lines, are avoided.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A method of cascade injection molding of injection-molded articles, said method including the steps of:
injecting the melt at more than one feed orifice using a needle valve-controlled needle valve nozzle associated with each feed orifice, into the cavity of the molding tool;
opening the needle valve nozzles at different times using a process means for controlling the opening speed of the needle valve nozzles, and the injection pressure at the feed orifices, via the corresponding piston-cylinder drives for the needle valve nozzles; and
throttling the pressurizing medium discharge from the piston cylinder for at least one of the piston-cylinder drives when the nozzle is opened.

2. A method of injection molding of injection-molded articles, said method including the steps of:
injecting the melt at one or more feed orifices using a needle valve-controlled needle valve nozzle associated with each feed orifice, into the cavity of the molding tool;
using a process means for controlling: via the corresponding piston-cylinder drive, the opening speed of the needle valve nozzle and thus the injection pressure at the feed orifice for the needle valve nozzle; and
throttling the pressurizing medium discharge from the piston cylinder drive for at least one of the piston-cylinder drives, when the nozzle is opened.

3. A method as set forth in claim 1, wherein at least one of the piston cylinder drives in the pressurizing medium line which is connected to the cylinder chamber of the piston cylinder drive via which the needle valve nozzle (D) can be closed, a throttle device with a one way element, which is disposed parallel thereto and only permits passage in the direction of the cylinder chamber is introduced.

4. A method as set forth in claim 1 wherein for at least one of the piston-cylinder drives, the piston rod is in additional mechanically coupled to a piston-cylinder device in which the two cylinder spaces are filled with a liquid pressurizing medium and are connected to one another via a short-circuit line, such that a throttle device is disposed in the short circuit line parallel thereto a one-way element whose direction of passage is such that it can be passed through on closing of the nozzle.

5. A method as set forth in claim 1, wherein the throttle device can be displaced.

6. A method as set forth in claim 5, wherein the throttle device is a throttle check valve.

7. A method as set forth in claim 5, wherein the throttle device is a proportional flow control valve.

8. A cascade injection molding system for injecting melt into a mold cavity, the system comprising:
a plurality of nozzles each having a valve rod driven by a piston-cylinder drive having a cylinder space, the plurality of nozzles for injecting the melt into the mold cavity;
a plurality of change-over valves coupled to a pressurizing medium line and a depressurized tank space, the change-over valves for controlling the piston-cylinder drives; and
a throttle check valve located within the pressurizing medium line for regulating the opening and closing of at least one nozzle according to a predetermined time delay, and to prevent explosive discharge of the melt into the mold cavity upon opening of at least one of the nozzles.

9. The cascade injection molding system of claim 8, wherein at least one of the piston-cylinder drives includes a plurality of cylinder spaces filled with a liquid pressurizing medium and are connected to one another via a short-circuit line having a throttle device and a one-way element disposed parallel thereto, the one-way element permitting passage upon closing of the nozzle.

10. The cascade injection molding system of claim 9, wherein the throttle device is displacable.

11. The cascade injection molding system of claim 10, wherein the throttle device is a throttle check valve.

12. The cascade injection molding system of claim 11, wherein the throttle device is a proportional flow control valve.

13. A method of injecting melt into a mold cavity, the method comprising the steps of:
opening a first nozzle and injecting a melt into the mold cavity via the first nozzle;
adjusting the opening seed of a second nozzle via a throttle check valve located within a pressurizing medium line coupled to the second nozzle to thereby regulate the injection pressure; and
opening the second nozzle and injecting the melt into the mold cavity via the second nozzle such that explosive discharge of the melt upon opening of the second nozzle is prevented.

14. The method set forth in claim 13, further including the step of opening the second nozzle after the first nozzle is opened and when the flow of the melt from the first nozzle reaches the second nozzle.
